(19) United States
(12) Patent Application Publication
(10) Pub. No.: US 2002/0112068 A1
(43) Pub. Date: Aug. 15, 2002

(54) METHOD AND APPARATUS FOR AUTOMATIC FRAME TYPE DETECTION IN A NETWORK

(76) Inventor: JOHN A. MURPHY, SAN ANTONIO, TX (US)

Correspondence Address: WITHROW & TERRANOVA, P.L.L.C., P.O. BOX 1287, CARY, NC, 27512, US

(21) Appl. No.: 09/081,882

(22) Filed: May 19, 1998

(51) Int. Cl. G06F 15/173; G06F 15/16

(52) U.S. Cl. 709/236

(57) ABSTRACT

A method and apparatus for automatic frame type detection in a network automatically identifies at least one frame type in use on a network. The method then selects one of the at least one frame types for a device coupled to the network to use.

### BACKGROUND OF THE INVENTION

1. Field of the Invention

The present invention pertains to networks and network protocols. More particularly, this invention relates to automatic frame type detection in a network.

2. Background

Computer systems are becoming more and more commonplace in educational, business, and personal fields. As more and more individuals are using computers, it is becoming increasingly commonplace to couple multiple computers together in a network. A wide variety of networks and networking protocols exist and, in order for a computer system on a network to access another computer system on the network, the two computer systems must typically be following the same protocol.

One difference between protocols is the way in which information is “packaged” together for transfer over the network. Protocols typically define a format for a “frame”, which is a series of contiguous bits transferred over the network. The format of the frame is referred to as the “frame type” and a single network can typically support multiple different frame types. The meaning of the bits in a frame is defined by the protocol and varies between protocols. Thus, in order for a device that is newly added to a network to accurately interpret data from another computer system received via the network and communicate with other devices on that network, the new device must know what frame type to use.

A new device to be added to a network is configured to use a frame type which is compatible with other devices on the network. A device can typically be configured by having a user input the frame type to the device. This input can be carried out by, for example, a user input to the device during installation, such as through the installation software, or by the setting of physical switches or jumpers on the device. Such solutions, however, can pose problems during installation, particularly when the user adding the device to the network has little or no knowledge of the frame types supported on the network, or even of what a frame type is.

Additionally, the modern trend is towards more user-friendly devices. However, requiring a user to be knowledgeable about the frame type on a network is more user-unfriendly. Thus, it would be beneficial to provide a way to automatically identify a frame type for a device on a network.

Furthermore, some devices have no consoles or displays which allow a user to input a frame type through the installation software. One such device is the Instant Internet¹⁰⁰™ device available from Bay Networks, Inc. of Santa Clara, Calif. Such devices are typically set up remotely by another computer system over the network. These devices present a particular problem because they communicate over the network with a remote system to be set up, yet they are unable to communicate over the network until they are set up.

Thus, a need exists for a method and apparatus for automatic frame type detection in a network.

### SUMMARY OF THE INVENTION

A method and apparatus for automatic frame type detection in a network is described herein. The computer-implemented method of the present invention automatically identifies at least one frame type in use on a network. The method then selects one of the at least one frame types for a device coupled to the network to use.

According to one embodiment of the present invention, at least one frame type is automatically identified by issuing a plurality of different requests on the network each using a plurality of different frame types, and then checking which requests and which frame types elicit responses from other devices on the network.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a network architecture such as may be used with one embodiment of the present invention;

FIG. 2 illustrates a frame such as may be used with one embodiment of the present invention;

FIG. 3 is a flow chart illustrating the steps followed in automatically detecting the frame type of a network according to one embodiment of the present invention;

FIG. 4 is a block diagram illustrating a network system in which one embodiment of the present invention is practiced;

FIG. 5 illustrates a hardware system or machine on which one embodiment of the present invention can be practiced; and

FIG. 6 is a block diagram illustrating a device on which one embodiment of the present invention is implemented.

### DETAILED DESCRIPTION

In the following detailed description numerous specific details are set forth in order to provide a thorough understanding of the present invention. However, it will be understood by those skilled in the art that the present invention may be practiced without these specific details. In other instances well known methods, procedures, components, and circuits have not been described in detail so as not to obscure the present invention.

In alternative embodiments, the present invention may be applicable to implementations of the invention in integrated circuits or chip sets, wireless implementations, switching systems products and transmission systems products. For purposes of this application, the terms switching systems products shall be taken to mean private branch exchanges (PBXs), central office switching systems that interconnect subscribers, toll/tandem switching systems for interconnecting trunks between switching centers, and broadband core switches found at the center of a service provider's network that may be fed by broadband edge switches or access multiplexors, and associated signaling, and support systems and services. The term transmission systems products shall be taken to mean products used by service providers to provide interconnection between their subscribers and their networks such as loop systems, and which provide multiplexing, aggregation and transport between a service provider's switching systems across the wide area, and associated signaling and support systems and services.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

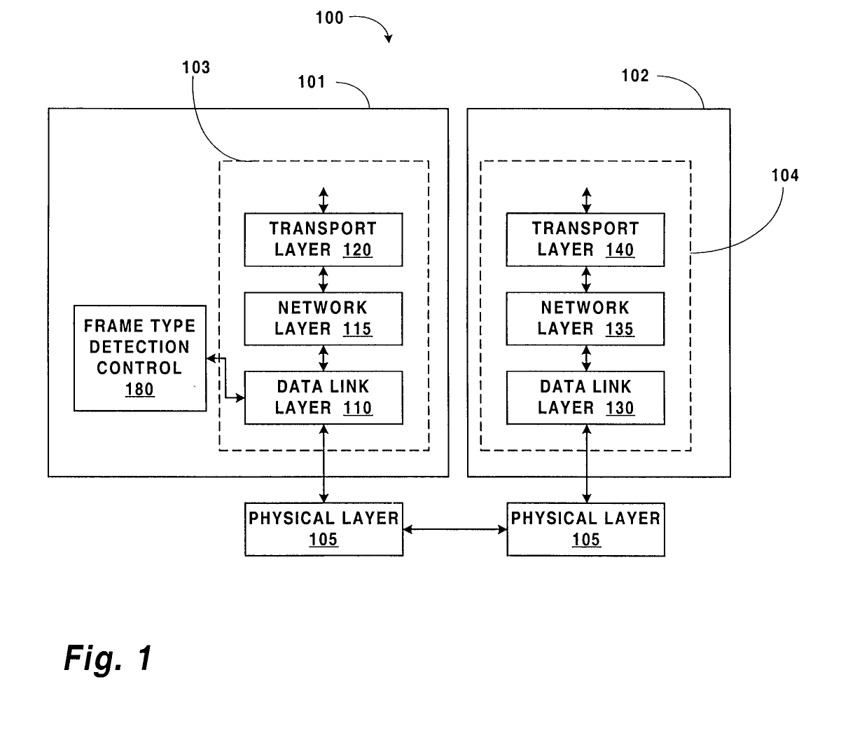

FIG. 1 is a block diagram illustrating a network architecture such as may be used with one embodiment of the present invention. A network architecture 100 is illustrated including network communication control “layers” 103 and 104 on two hardware systems 101 and 102, respectively. Examples of such hardware systems include computer systems, gateways, routers, etc. Hardware system 101 includes a data link layer 110, a network layer 115, and a transport layer 120. Different applications and networking protocols can communicate over the network using network architecture 100. Data to be transferred from hardware system 101 to hardware system 102 over the network is received by transport layer 120 from higher level applications (not shown). Transport layer 120 is responsible for ensuring that all of such data is correctly transferred to/from the target/source via the network.

The transport layer 120 communicates with the network layer 115. Network layer 115 separates the data from transport layer 120 into one or more packets and is responsible for determining how these packets are to be transferred to/from other devices on the network. According to one embodiment of the present invention, the network layer 115 supports the Internetwork Packet Exchange (IPX) protocol. The network and data link layers which support the IPX protocol are also referred to as the IPX “stack”.

The network layer 115 communicates with the data link layer 110, which in turn communicates with the physical layer 105. Data link layer 110 encapsulates IPX packets received from network layer 115 into a frame for transfer over the physical layer 105. Thus, network layer 115 and higher layers can operate without concern for the frame type(s) being used on the network. The frame type into which the IPX packet is encapsulated is dependent on how the particular device is configured.

Hardware systems 101 and 102 are coupled to one another via the physical layer 105. According to one embodiment of the present invention, the physical layer 105 is an Ethernet network. An Ethernet network is typically capable of supporting at least four different frame types. Four common frame types are: Ethernet_II, IEEE 802.2, IEEE 802.3, and Ethernet_SNAP. Each of these four frame types are well-known to those skilled in the art and thus will not be discussed further except as they pertain to the present invention. However, in alternate embodiments, different frame types and/or different networks are supported. For example, in one such alternate embodiment a token ring network is supported.

As illustrated, hardware system 102 includes a data link layer 130, network layer 135, and transport layer 140. These layers of hardware system 102 operate analogously to those of hardware system 101. Data received by hardware system 102 from hardware system 101 via physical layer 105 is transferred to the data link layer 130. Data link layer 135 extracts the IPX packet(s) from the frame. It is to be appreciated that such extraction is dependent on the frame type.

The IPX packet is then transferred to network layer 135, which ensures the transfer of data to transport layer 140 in the proper order in accordance with the IPX protocol. By way of example, packets may be received by hardware system 102 in a different order than they were sent by hardware system 101—network layer 135 ensures that the proper ordering of packets is obtained before passing the data to transport layer 140. Transport layer 140 then provides the received data to the higher-level applications (not shown) of hardware system 102.

The multiple layers of network architecture 100 are well-known to those skilled in the art, and thus will not be discussed further except as they pertain to the present invention.

Hardware system 101 also includes frame type detection control 180. Frame type detection control 180 interacts with data link layer 110 during initialization of system 101 in order to automatically detect possible frame types which system 101 may be configured with. Frame type detection control 180 directs data link layer 110 to issue multiple requests using multiple frame types as discussed in more detail below.

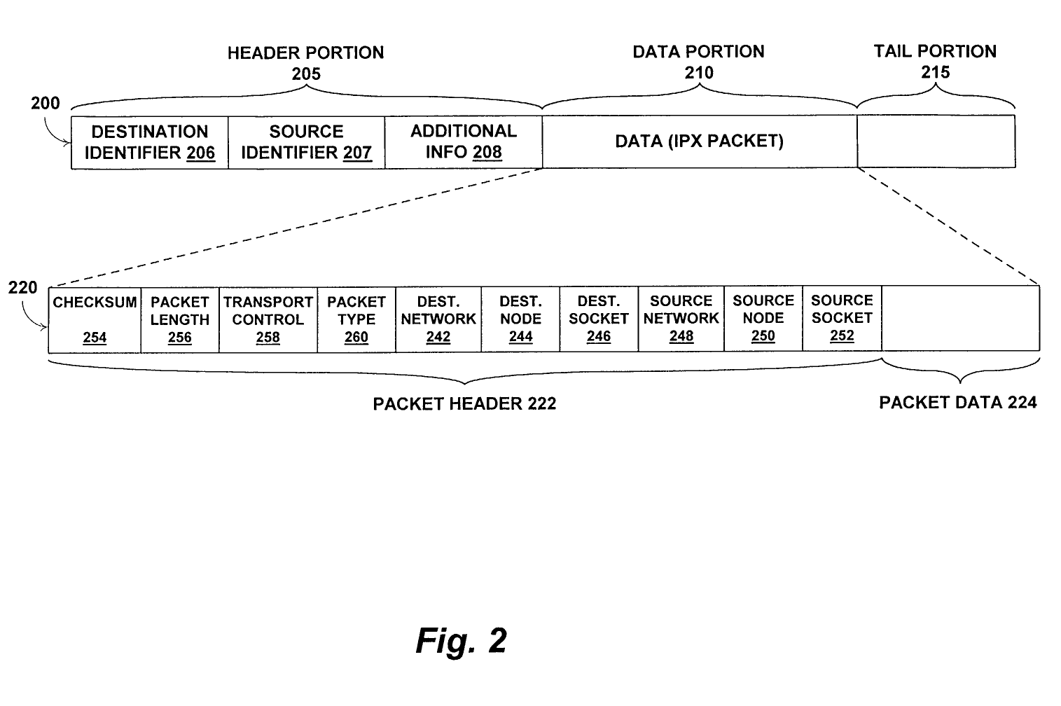

FIG. 2 illustrates a frame such as may be used with one embodiment of the present invention. A frame 200 is illustrated including a header portion 205, a data portion 210, and a tail portion 215. Data portion 210 includes the data being transferred in the frame, illustrated as IPX packet 220. Tail portion 215 includes different control information, such as a checksum, dependent on the frame type. Header portion 205 includes a destination identifier 206, a source identifier 207, and additional information 208.

As discussed in more detail below, a network can be made up of multiple network segments coupled together by one or more servers, routers, gateways, bridges, etc. Destination identifier 206 identifies the destination for the frame within a network segment while source identifier 207 identifies the source of the frame within the network segment. The destination identifier 206 and the source identifier 207 are both six bytes on an Ethernet network. The additional information 208, however, includes different information, and can be different sizes, for different frame types. For example, if frame 200 is an Ethernet_II frame, then the additional information 208 is “type” information regarding the remainder of the frame. However, if frame 200 is an IEEE 802.3 frame, then the additional information 208 is length information which identifies the length of the frame 200. Thus, given the different information that can be stored in the header portion 205 as additional information 208, it is important that the device know the particular frame type in order to communicate with other devices over the network. Otherwise, a receiving device may incorrectly interpret the data of a frame.

The IPX packet 220 includes a packet header 222 and packet data 224. The packet data 224 is the information that is being transferred by the transport layers of the communicating devices. A packet header 222 includes various control information regarding the packet data 224 as well as the source and destination networks and nodes.

The destination network identifier 242 allows the data 224 to be transferred between network segments. For example, for a packet which is to be transferred from a first device on a first network segment to a second device on a second network segment, and with the first and second network segments being coupled together via a router, then the destination network identifier 242 identifies the second network segment while the destination node identifier 244 identifies the second device. When the frame is transferred from the first device to the router the frame has, as destination identifier 206, the router. Upon receipt of the frame 200, the router identifies the ultimate destination of the frame 200 (based on identifiers 242 and 244) and issues the frame on the second network segment with a destination identifier 206 of the second device.

Additional control information is also included in packed header 222. A destination socket identifier 246 is included which identifies a particular socket of the destination device to receive the frame. Network identifier 248, node identifier 250, and socket identifier 252 for the source of the frame are also included. A checksum 254 is included for error checking/correcting purposes, and the length of IPX packet 220 is included as packet length 256. Transport control identifier 258 identifies the number of routers through which packet 220 passes between the source and destination nodes, while packet type identifier 260 identifies the type of packet. The contents and use of packet header 222 are well-known to those skilled in the art and thus will not be discussed further except as they pertain to the present invention.

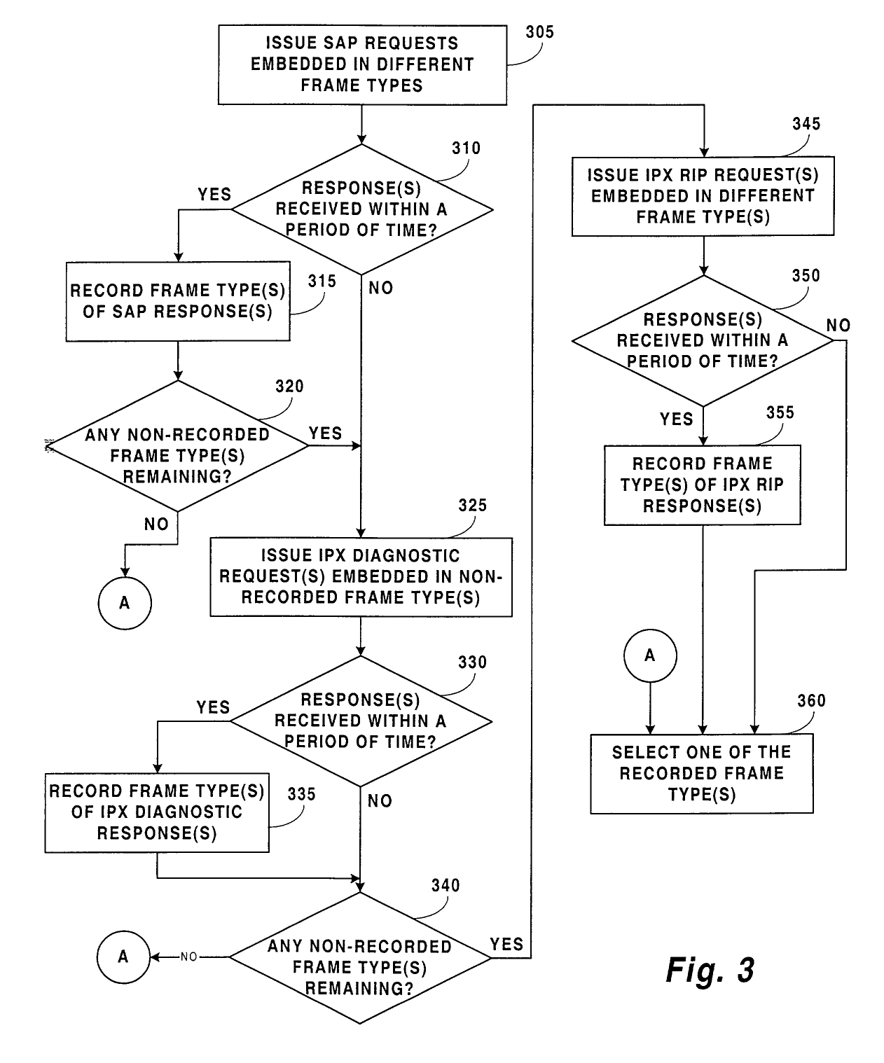

FIG. 3 is a flow chart illustrating the steps followed in automatically detecting the frame type of a network according to one embodiment of the present invention. The steps of FIG. 3 are carried out by a particular device on the network to identify one or more frame types which may be selected from for use by that device. In one implementation, the steps of FIG. 3 are carried out by frame type detection control 180 in conjunction with data link layer 110 of FIG. 1.

The device first embeds a service advertising protocol (SAP) request in each of multiple different frame types and issues the frames on the network, step 305. According to one implementation, the requesting device is pre-programmed with each of the possible frame types for the network, as well as the protocols for those frame types, thereby allowing the requesting device to send a frame using each of these different frame types. In the illustrated embodiment, a request is issued in step 305 for each of these possible frame types.

The SAP request is made by setting the destination socket of the IPX packet (identifier 246 of FIG. 2) to be that for service advertising packets (e.g., 0×0452) and inserting a SAP request into the packet data (identifier 244 of FIG. 2). In one implementation, the SAP request issued by the device requests the address of the nearest file server. All IPX file servers that are using the selected frame type and that are on the same network segment as the device will understand the SAP request and typically will respond to it. If there are no IPX file servers on that network segment, but one or more such servers exists somewhere on the interconnected network, then at least one IPX router on the network segment will respond to the SAP request. It should be noted, however, that the servers and/or routers on the network (if any) will respond to only the particular frame type that they are configured for, and that they will respond using the frame type they are configured for. The requests embedded in other frame types will not be interpreted as valid requests by another device on the network unless it is configured for that frame type, and thus such requests will not elicit responses from the other devices.

The requesting device then checks whether any responses to the SAP requests in any of the frame types are received within a particular period of time, step 310. According to one embodiment of the present invention, this particular period of time is two seconds, however, different periods can be used in different embodiments. In one implementation, the period of time to wait is determined by balancing the desire to not wait too long for a response which should typically come quickly against the desire to make sure a response is not missed due to network traffic or a particularly busy server. Typical periods of time to wait range from one-half second to ten seconds.

If a response(s) is received within the period of time, then the requesting device records the frame type of the received response(s), step 315. Each response indicates to the requesting device that another device on the network is using the frame type of the response. Thus, the device knows it can communicate with at least one other device on the network using that particular frame type. It should be noted that it is the receipt of a response to the SAP request rather than the particular content of that response that the requesting device is waiting for.

If a response(s) to the SAP requests is received, the requesting device proceeds after the period of time expires (or alternatively, after all possible frame types have been recorded in step 315), to check whether any non-recorded frame types remain, step 320. If all possible frame types have been recorded in step 315, then the device proceeds to step 360, discussed in more detail below.

If any non-recorded frame types remain after step 315, or if no responses to the SAP requests are received, then the device embeds an IPX diagnostic request in each of the non-recorded frame types and issues the frames on the network, step 325. Thus, the device re-checks all of the possible frame types, except any recorded in step 315, using a different request.

The IPX diagnostic request is made by setting the destination socket to be that for diagnostic requests (e.g., 0×0456) and inserting a diagnostic request for IPX-SPX components into the packet data. Any device on the network segment with an IPX driver installed will typically respond to the IPX diagnostic request. Thus, if there is a workstation or other device on the network segment with an IPX driver installed, even if there is no file server, and the workstation or other device configured to the selected frame type, then the requesting device will receive a response.

If any responses to the IPX diagnostic requests in any of the frame types are received by the requesting device within a particular period of time (e.g., two seconds), step 330, then the requesting device records the frame type of the received response(s), step 335. Analogous to the discussion above, it is the response that the device is waiting for rather than the contents of any particular response.

After the period of time expires (or alternatively, after all possible frame types have been recorded in steps 315 and/or 335), the device checks whether any non-recorded frame types remain, step 340. If all possible frame types have been recorded in steps 315 and/or 335, then the device proceeds to step 360, discussed in more detail below. However, if any non-recorded frame types remain, then the device embeds an IPX routing information protocol (RIP) request in each of the non-recorded frame types and issues the frames on the network, step 345. Thus, the device re-checks all of the possible frame types, except any recorded in steps 315 and/or 335, using a different request.

The IPX RIP request is made by setting the destination socket to be that for RIP requests (e.g., 0×0453) and inserting a RIP request for all networks into the packet data. In one implementation, the RIP request issued by the device requests that information for all network segments of the interconnected network respond. All IPX servers and all IPX routers will typically respond to the RIP request.

If any responses to the IPX RIP requests in any of the frame types are received by the requesting device within a particular period of time (e.g., two seconds), step 350, then the requesting device records the frame type of the received response(s), step 355. Analogous to the discussions above, it is the response that the device is waiting for rather than the contents of any particular response.

After the period of time expires (or alternatively, after all possible frame types have been recorded in steps 315, 335, and/or 355), the device proceeds to select one of the recorded frame types, step 360. These recorded frame types are those from steps 315, 335, and 355. According to one embodiment of the present invention, the selection is made by presenting a list to the user of the possible frame types and allowing him or her to select one. In this embodiment, the list may be presented to a user on a remote system. According to one implementation, the device temporarily selects one of the possible frame types (one of those recorded from steps 315, 335, and 355). This allows a remote system to contact the device, which is done by the remote system sending a Get Nearest Server SAP request requesting the address of the nearest Instant Internet™ device (performed in an analogous manner to the SAP request discussed above with reference to step 305). This allows the device and the remote system to communicate with one another, and thus allows the device to identify the possible frame types from those recorded in steps 315, 335, and 355 to the remote system, and allows a user of the remote system to select one of the possible frame types.

Alternatively, the device may be pre-programmed with a particular “preferred” ordering, and it will select the one of the recorded frame types which is most preferred. In another alternate embodiment, if only one frame type is recorded, then that is the only possible configuration option and the device selects that option automatically without need for user input.

It should be noted that the SAP requests, REP requests, and IPX diagnostic requests discussed above are “broadcast” to all devices on the network segment rather than being sent to particular devices. Thus, any device on the network segment can respond.

Thus, following steps 305-355, a list of possible frame types on the network segment can be identified as long as there is at least one other device on the network segment (whether it be a router, workstation, file server, gateway, bridge, etc.) using IPX. It is to be appreciated that if there are no other IPX configured devices on the network, then any of the four possible frame types can be selected because there is no other device to be communicating with.

FIG. 3 illustrates automatic detection of frame type according to one embodiment of the present invention. However, various alternate embodiments of the present invention exist which are modifications to the embodiment of FIG. 3. According to one such alternate embodiment, the device selects as its frame type the first selected frame type to elicit a response rather than recording all frame types which elicit responses. According to another such alternate embodiment, the device selects as its frame type a “most preferred” from a particular “preferred” ordering as soon as that frame type elicits a response. According to another such alternate embodiment, the device issues a request embedded in one frame type and waits a period of time for a response before sending a request embedded in another frame type. According to another such alternate embodiment, requests for all frame types are issued regardless of which may have been stored (e.g., in step 315, step 335, and/or step 355) from previous requests or previous frame types of the same request.

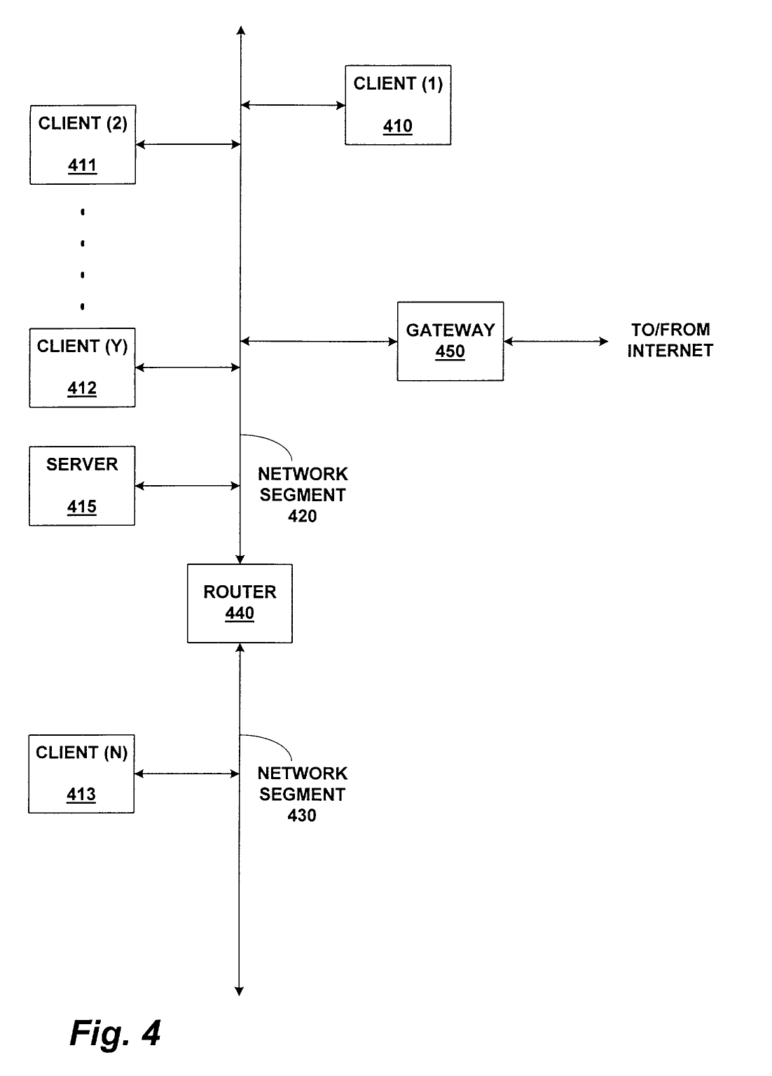

FIG. 4 is a block diagram illustrating a network system in which one embodiment of the present invention is practiced. An interconnected network is illustrated including two network segments 420 and 430 coupled together via a router 440. Multiple (Y) client systems 410, 411, and 412 are coupled to network segment 420, while one or more (N) client systems 413 are coupled to network segment 430. A server 415 is also coupled to network segment 420. Server 415 provides a service to the client systems 410-413. By way of example, server 415 may be a file server or a print server.

In the illustrated embodiment network segments 420 and 430 together comprise a local area network (LAN) of any of a wide variety of conventional types, such as an Ethernet or Token Ring network. The LAN conforms to any of a wide variety of conventional networking protocols, such as the Windows 95™, Windows NT™, or Novell Netware™ networking protocols.

The network system 400 also includes a gateway 450. The gateway 450 provides an interface between the Internet and network segments 420 and 430. Requests from one of the client systems 410-413 are received by the gateway 450 in accordance with the protocol of the LAN. The gateway 450 then forwards the requests to the Internet, either directly or via an ISP. Similarly, data from another system on the Internet which targets one of the client systems 410-413 (e.g., a response to an Internet request sent by one of the client systems) is received by the gateway 450 and forwarded to the appropriate client system 410-413 using the protocol of the network 440. In one implementation, the gateway 450 is an Instant Internet¹⁰⁰™ device available from Bay Networks, Inc.

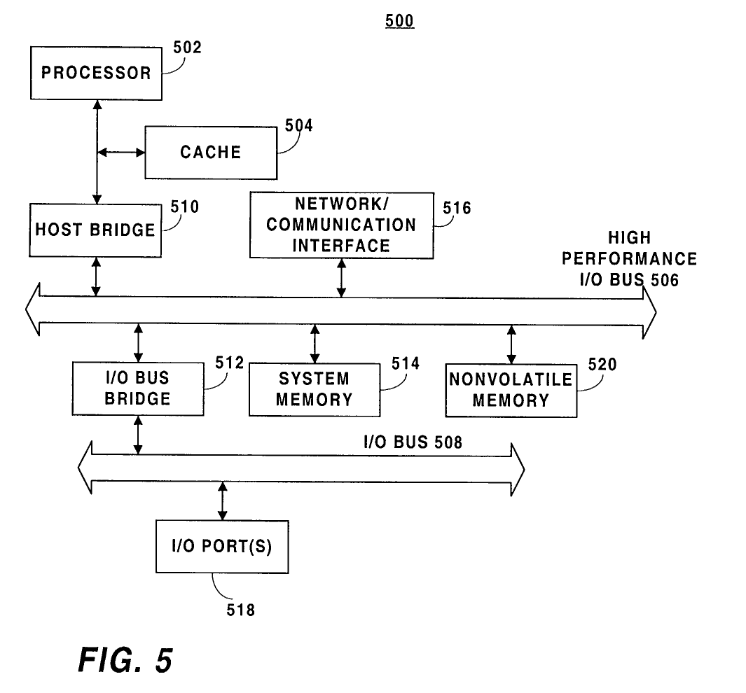

FIG. 5 illustrates a hardware system or machine on which one embodiment of the present invention can be practiced. In one embodiment, the hardware system 101 illustrated in FIG. 1 and the gateway 450 illustrated in FIG. 4 are each a hardware system 500 of FIG. 5. In the illustrated embodiment, hardware system 500 includes processor 502 and cache memory 504 coupled to each other as shown. Additionally, hardware system 500 includes high performance input/output (I/O) bus 506 and standard I/O bus 508. Host bridge 510 couples processor 502 to high performance I/O bus 506, whereas I/O bus bridge 512 couples the two buses 506 and 508 to each other. Network/communication interface 516 and system memory 514 are coupled to high performance I/O bus 506, and additional I/O ports 518 are coupled to I/O bus 508. I/O ports 526 are one or more serial and/or parallel communication ports used to provide communication between additional peripheral devices which may be coupled to hardware system 500. Collectively, these elements are intended to represent a broad category of hardware systems, including but not limited to the Instant Internet™ device available from Bay Networks of Santa Clara, Calif., or general purpose computer systems based on processors available from Intel Corporation of Santa Clara, Calif., from Advance Micro Devices (AMD) of Sunnyvale, Calif., from National Semiconductor of Sunnyvale, Calif., or from Digital Equipment Corporation (DEC) of Maynard, Mass.

These elements 502-518 perform their conventional functions known in the art. In particular, network/communication interface 516 is used to provide communication between system 500 and any of a wide range of conventional networks, such as an Ethernet, token ring, the Internet, etc. It is to be appreciated that the circuitry of interface 516 is dependent on the type of network the system 500 is being coupled to. In one implementation, hardware system 500 is coupled to network segment 420 of FIG. 4 via network/communication interface 516. One or more additional network/communication interfaces (not shown) may also be coupled to high performance I/O bus 506 or standard I/O bus 508 for communicating with another network, such as the Internet.

According to one embodiment of the present invention, a nonvolatile memory 520, such as a ROM or Flash memory, is also coupled to I/O bus 506 (or alternatively I/O bus 508) to provide permanent storage for data and programming instructions to perform the above described functions of automatic frame type detection of FIG. 3, whereas system memory 514 is used to provide temporary storage for the data and programming instructions when executed by processor 502. According to an alternate embodiment of the present invention, nonvolatile memory 520 also provides permanent storage for data and programming instructions which enable the hardware system 500 to receive additional data and programming instructions from another network device (such as a client system 410-413 of FIG. 4) via interface 516 and store the data and instructions in the system memory 514.

It is to be appreciated that various components of hardware system 500 may be rearranged. For example, cache 504 may be on-chip with processor 502. Alternatively, cache 504 and processor 502 may be packaged together as a “processor module” and attached to a “processor card”, with processor 502 being referred to as the “processor core”. Furthermore, certain implementations of the present invention may not require nor include all of the above components. For example, cache 504 or I/O ports 518 may not be included in system 500. Additionally, the peripheral devices shown coupled to standard I/O bus 508 may be coupled to high performance I/O bus 506; in addition, in some implementations only a single bus may exist with the components of hardware system 500 being coupled to the single bus. Furthermore, additional components may be included in system 500, such as additional processors, mass storage devices, memories, video memories, display devices, keyboard devices, pointing devices, etc.

In alternate embodiments of the present invention, hardware system 500 is less complex than illustrated. By way of example, processor 502, system memory 514, and network/communication interface 524 could be implemented in a microcontroller or an application specific integrated circuit (ASIC).

In one embodiment, the method of FIG. 3 is implemented as a series of software routines run by hardware system 500 of FIG. 5. These software routines comprise a plurality or series of instructions to be executed by a processor in a hardware system, such as processor 502 of FIG. 5. Initially, the series of instructions are stored on a storage device, such as nonvolatile memory 520. It is to be appreciated that the series of instructions can be stored on any conventional storage medium, such as a hard disk, removable diskette, CD-ROM, magnetic tape, DVD, laser disk, etc. It is also to be appreciated that the series of instructions need not be stored locally, and could be received from a remote storage device, such as a server on a network, via network/communication interface 516.

The instructions are copied from the storage device (or remote source) into memory 514 and then accessed and executed by processor 502. In one implementation, these software routines are written in the C programming language. It is to be appreciated, however, that these routines may be implemented in any of a wide variety of programming languages.

In alternate embodiments, the present invention is implemented in discrete hardware or firmware. For example, in one alternate embodiment, an application specific integrated circuit (ASIC) is programmed with the above described functions of the present invention.

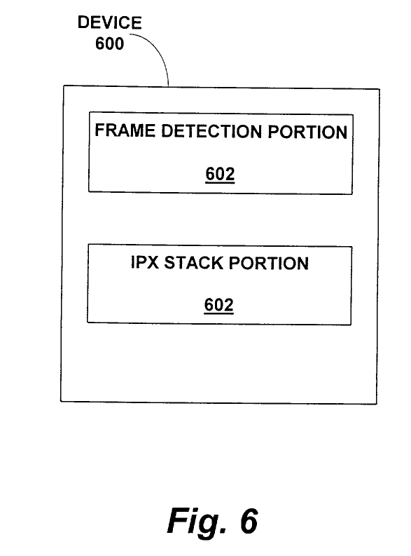

FIG. 6 is a block diagram illustrating a device on which one embodiment of the present invention is implemented. The device 600 represents a wide variety of machine-readable media in which the present invention can be implemented, including conventional storage devices (such as a floppy disk, random access memory, or Flash memory), as well as discrete hardware or firmware.

The device 600 includes a frame detection portion 602 and an IPX stack portion 604. In embodiments where the present invention is implemented in software or firmware, frame detection portion 602 includes the instructions, to be executed by a processor, for carrying out the automatic frame detection of FIG. 3. Similarly, IPX stack portion 604 includes the instructions, to be executed by a processor, for communicating with other devices via the network according to the IPX protocol. In embodiments where the present invention is implemented in hardware, frame detection portion 602 includes the logic for carrying out the automatic frame detection of FIG. 3. Similarly, IPX stack portion 604 includes the logic for communicating with other devices via the network according to the IPX protocol.

Thus, a method and apparatus for automatic frame type detection in a network has been described. Whereas many alterations and modifications of the present invention will be comprehended by a person skilled in the art after having read the foregoing description, it is to be understood that the particular embodiments shown and described by way of illustration are in no way intended to be considered limiting. References to details of particular embodiments are not intended to limit the scope of the claims.

What is claimed is:

1. A computer-implemented method comprising:
automatically identifying at least one frame type in use on a network; and
selecting one of the at least one frame types for a device coupled to the network to use.

2. The method of claim 1, wherein the identifying comprises:
issuing a plurality of different requests on the network each using a plurality of different frame types; and
checking which requests and which frame types elicit responses.

3. The method of claim 2, wherein the plurality of different requests includes one or more of a service advertising protocol (SAP) request, an IPX diagnostic request, and an IPX routing information protocol (RIP) request.

4. The method of claim 2, wherein the plurality of different frame types includes one or more of an Ethernet_II frame type, an IEEE 802.2 frame type, an IEEE 802.3 frame type, and an Ethernet_SNAP frame type.

5. The method of claim 1, wherein the identifying comprises:
issuing a first request on the network using at least one of a plurality of different frame types; and
checking whether the at least one of the plurality of different types elicits a response to the first request.

6. The method of claim 1, wherein the selecting comprises:
providing an option list including at least one of the at least one frame types in use on the network; and
selecting a chosen frame type from the option list as the frame type to use.

7. A machine-readable medium having stored thereon a plurality of instructions, designed to be executed by a processor, for implementing a function for automatically identifying at least one frame type in use on a network, and for selecting one of the at least one frame types for a device coupled to the network to use.

8. The machine-readable medium of claim 7, wherein the plurality of instructions for implementing a function for identifying comprises a plurality of instructions for implementing a function for issuing a plurality of different requests on the network each using a plurality of different frame types and checking which requests and which frame types elicit responses.

9. The machine-readable medium of claim 8, wherein the plurality of different requests includes one or more of a service advertising protocol (SAP) request, an IPX diagnostic request, and an IPX routing information protocol (RIP) request.

10. The machine-readable medium of claim 8, wherein the plurality of different frame types includes one or more of an Ethernet_II frame type, an IEEE 802.2 frame type, an IEEE 802.3 frame type, and an Ethernet_SNAP frame type.

11. The machine-readable medium of claim 7, wherein the plurality of instructions for implementing a function for identifying comprises a plurality of instructions for issuing a first request on the network using at least one of a plurality of different frame types and for checking whether the at least one of the plurality of different types elicits a response to the first request.

12. The machine-readable medium of claim 7, wherein the plurality of instructions for implementing a function for selecting comprises a plurality of instructions for providing an option list including at least one of the at least one frame types in use on the network, and for selecting a chosen frame type from the option list as the frame type to use.

13. An apparatus comprising:
network control logic to control communication over a network; and
frame detection logic, coupled to the network control logic, to automatically identify at least one frame type in use on a network and to select one of the at least one frame types for the network control logic to use.

14. The apparatus of claim 13, wherein the frame detection logic is to identify the at least one frame type by issuing a plurality of different requests on the network each using a plurality of different frame types and checking which requests and which frame types elicit responses.

15. The apparatus of claim 14, wherein the plurality of different requests includes one or more of a service advertising protocol (SAP) request, an IPX diagnostic request, and an IPX routing information protocol (RIP) request.

16. The apparatus of claim 14, wherein the plurality of different frame types includes one or more of an Ethernet_II frame type, an IEEE 802.2 frame type, an IEEE 802.3 frame type, and an Ethernet_SNAP frame type.

17. The apparatus of claim 13, wherein the frame detection logic is to identify the at least one frame type by issuing a first request on the network using at least one of a plurality of different frame types and checking whether the at least one of the plurality of different types elicits a response to the first request.

18. The apparatus of claim 13, wherein the frame detection logic is to select the one of the at least one frame types by providing an option list including at least one of the at least one frame types in use on the network, and selecting a chosen frame type from the option list as the frame type to use.

19. An apparatus comprising:
means for automatically identifying at least one frame type in use on a network; and
means, coupled to the means for automatically identifying, for selecting one of the at least one frame types for a device coupled to the network to use.

20. The apparatus of claim 19, wherein the means for automatically identifying comprises:
means for issuing a plurality of different requests on the network each using a plurality of different frame types; and
means for checking which requests and which frame types elicit responses.

21. The apparatus of claim 20, wherein the plurality of different requests includes one or more of a service advertising protocol (SAP) request, an IPX diagnostic request, and an IPX routing information protocol (RIP) request.

22. The apparatus of claim 20, wherein the plurality of different frame types includes one or more of an Ethernet_II frame type, an IEEE 802.2 frame type, an IEEE 802.3 frame type, and an Ethernet_SNAP frame type.

23. The apparatus of claim 19, wherein the means for automatically identifying comprises:
means for issuing a first request on the network using at least one of a plurality of different frame types; and
means for checking whether the at least one of the plurality of different types elicits a response to the first request.

24. The method of claim 19, wherein the means for selecting comprises:
means for providing an option list including at least one of the at least one frame types in use on the network; and
means for selecting a chosen frame type from the option list as the frame type to use.
